(19) United States
(12) Patent Application Publication
(10) Pub. No.: US 2012/0123562 A1
(43) Pub. Date: May 17, 2012

(54) CONTROL SYSTEM FOR CONTROLLING A PROCESS

(75) Inventor: Viktor Oster, Blomberg (DE)

(73) Assignee: PHOENIX CONTACT GMBH & CO. KG, BLOMBERG (DE)

(21) Appl. No.: 13/321,584

(22) PCT Filed: May 19, 2010
(86) PCT No.: PCT/EP2010/056884

§ 371 Date: Jan. 25, 2012

(30) Foreign Application Priority Data
May 22, 2009 (DE) 10 2009 022 389.4

(51) Int. Cl. G05B 9/02

(52) U.S. Cl. 700/12

(57) ABSTRACT

The invention relates to a control system for controlling a process, comprising a safety module (1) and an output module (2), wherein the safety module (1) provides a definite signal (4), the output module (2) has an output (5) for outputting the definite signal (4) to control the process, the output module (2) has a means for reading back (6) an actual state of the output (5), wherein by means of the safety module (1) the actual state read back can be compared with a target state and in the event of a difference between the actual state and the target state the process can be brought to a safe state. According to the invention, a control system for controlling a process, in particular for controlling a safety-related process, that can be used in very cost-effective way in particular for safety-related applications is thereby specified. The invention further relates to a control device and a method for controlling a process

### FIELD OF TECHNOLOGY

The invention relates to a control system as well as a control device for controlling a process with a safety module and an output module. Furthermore, the invention relates to a method for controlling a process with a safety module and an output module.

### BACKGROUND

Control systems for controlling a process, particularly a safety-relevant process, are of superior importance in many fields of applications, such as in automation technology. Such control systems, which can also be implemented as field bus systems, typically comprise a plurality of signal units or bus participants connected to the processes to be controlled, and generally comprise a bus master, which controls a frame-based communication via a so-called field bus telegram via the field bus. Such field bus systems known from prior art offer a multitude of possibilities for controlling the process, however it is frequently problematic to design such field bus systems such that they meet safety-relevant requirements.

In this context, a safety-relevant process is considered particularly a process, which in case of an error occurring leads to a risk for humans and/or material assets, which may not be ignored. Thus, in case of an error occurring, a control system controlling a safety-relevant process is required to transfer the process and/or an overall system comprising the process into a safe mode. Examples of safety-relevant processes are chemical processes, in which critical parameters must mandatorily be kept within a predetermined range, complex machine controls, such as in a hydraulic press or a production line, in which for example the start-up operation of a pressing/cutting tool may represent a safety-relevant process. Additional examples of safety-relevant processes are the monitoring of protective grids, protective doors, or light bars, the control of safety switches, or the reaction of emergency shut-off switches.

For safety-relevant processes it is therefore mandatory that the hardware and software of the devices used show different measures, such as several shut-off means for safety-relevant outlets, redundancies of the circuits, diagnostic circuits, error-detecting measures of the software, or protection from insufficient or excess voltage, in order to fulfill the requirements. Generic standards to meet safety-relevant requirements are particularly found in the safety standards DIN EN 61508, DIN EN 62061, or DIN EN ISO 13849.

Control systems are known from prior art comprising safety-relevant outlets, with the outlets being inside the shut-off path, they themselves however not performing any safety functions according to the above-mentioned safety standards. Such safety-relevant outlets are controlled for example in case of an error or a safety requirement by secure outlet modules, thus outlet modules according to a safety standard named above, which must be operated or addressed locally by a secure control. However, the costs for the hardware as well as the engineering expense of such control systems known from prior art are very high. Furthermore, such control systems can only be used to a limited extent due to insufficient diagnostic possibilities.

Furthermore, in such control systems it is disadvantageous that a cross fault at the safety-relevant outlet and/or a cross fault between outlets that must be supplied by the very same secure outlet module is not detected, and in such a case an arrangement controlled by the control system as well as the operating personnel might be in danger.

### SUMMARY

The invention is based on the objective to provide a control system, a control device, as well as a method for controlling a process, which allows in a particularly simple and beneficial manner a particularly safe control of the process.

The objective is attained according to the invention by the features of the independent claims. Advantageous embodiments of the invention are shown in the dependent claims.

Accordingly, the objective is attained in a control system for controlling a process, comprising a safety module and an output module, with the safety module providing a secure signal, the output module comprising an outlet for issuing the secure signal to control the process, the output module comprising a means to detect the actual status of the outlet. Using the safety module, the detected actual status can be compared with a target status and in case of a difference between the actual status and the target status the process can be transferred into a safe mode.

According to the invention, in this way a control system of a process is provided, particularly for controlling a safety-relevant process, which can be used in a very cost-effective manner particularly for safety-relevant applications, because the outlet module provides diagnostic information and/or status information of the outlet to the safety module by detecting the actual status.

The control system according to the invention allows therefore a simple and clean separation between the standard technology, such as the outlet module, thus the components of the control system, which are not subject to the above-mentioned safety standards for safety-relevant processes, and the safety technology, such as the safety module, thus the components of the control system subject to the above-mentioned safety standards for safety-relevant processes, so that the construction size of the components used in the control system according to the invention compared to known components of prior art can be reduced. Due to the fact that the safety module, which is embodied preferably according to the above-mentioned safety standards, fulfills the requirements to control a safety-relevant process according to the above-mentioned safety standards, the control system according to the invention also fulfills the requirements of the aforementioned safety standards.

The output module may also be embodied as an output module known from prior art, such as an output device with outlets for connecting actuators, such as engines or triggers, with the output module according to the invention comprising a means for detecting the actual status of the outlet. Furthermore it is preferred that the secure signal is embodied as a secure voltage. Here, the adjective “secure” of the secure signal shall be interpreted such that it fulfills the requirements of the aforementioned safety standards. In other words, a signal represents a secure signal, such as a secure voltage, which fulfills the requirements of the different safety standards, such as for example DIN EN 61508, DIN EN 62061, or DIN EN ISO 13849.

A safe mode is considered such a condition which prevents a potential endangering of the facility and/or the operating personnel and which must be assumed in case of malfunctions. Generally, the energy-free status is the safe mode for the field of automation technology.

According to the invention it is therefore provided that the safety module provides the secure signal by which the output module controls the process. Furthermore it is preferred that the output module of prior art comprises known devices for a potential separation, such as an optocoupler, and/or devices for controlling the output, such as a semiconductor switch. Furthermore, it is preferred that the voltage representing the secure signal is embodied as the means for detecting the actual status of the outlet in the form of a means for detecting a voltage, thus, for example, as a means for measuring the voltage.

The control system according to the invention therefore allows the monitoring of a signal for controlling a process such that errors in the output of a signal, such as, for example, a short in the optocoupler of the output module, can be detected in a simple and secure fashion by shorting the electronic component in the output module or a cross fault of an output and/or an actuator connected to said output, and in case of a difference between such a detected actual status from the target status the process can be transferred into a safe mode.

In general, the transfer of the process into a safe mode can occur in any arbitrary manner in case of a difference between the actual status and the target status. Here, according to another preferred embodiment of the invention it may be provided that the process can be transferred by shutting off the secure signal into the safe mode. In case of a secure voltage as the secure signal this may also occur by shutting off the secure voltage, preferably by the safety module. Furthermore, it is preferred that shutting off the secure signal occurs by an emergency switch. By shutting off the secure signal it is also achieved that the secure signal for controlling the process is no longer connected to the output of the output module.

According to another preferred exemplary embodiment of the invention it is provided that a control and/or a secure control for addressing the safety module and/or the output module is provided, with the target status being predetermined by the control and/or by the secure control. Furthermore, it is preferred that the safety module is embodied as a secure control according to the above-mentioned safety standards. Furthermore, it is preferred that the detected actual status can be transmitted from the output module to the control and/or to the secure control and the detected actual status can be forwarded from the control and/or the secure control to the safety module.

Therefore, the control according to the present preferred embodiment of the invention, preferably embodied as a control for process automation known from prior art, performs the communication between the safety module and the output module such that the actual status detected by the output module is transmitted via the control to the safety module for comparison with the target status. Then the safety module checks if there is a difference between the actual status and the target status, for example, due to a cross fault, and in case a difference is found the process is transferred into a safe mode. Due to the fact that the safety module is implemented according to the requirements of the above-mentioned safety standards error conditions listed in the above-mentioned safety standards can also be detected by the safety module, which then also can lead to a transfer of the process into the safe mode. In other words, it is therefore preferred that the control manages the process, while the secure output module only interferes in case of an error or in case of a safety requirement.

In principle, the communication between the safety module, the output module, and the control and/or the secure control can occur arbitrarily. According to another preferred embodiment of the invention it is provided, though, that a field bus is provided for the communication between the safety module, the output module, and the control and/or the secure control. The field bus is preferably embodied as a field bus known from prior art, such as interbus, profibus, or profinet. Due to the fact that the detected actual status is transmitted between the safety module and the output module, thus no secure data is transmitted between the safety module and the output module, a cost-effective and simple implementation of the control system can occur, for example, via a field bus known from prior art.

According to another preferred embodiment of the invention the control system is embodied as a field bus arrangement. Particularly preferred, the control system is used for the automation of an arrangement. The objective is furthermore attained by a control device for controlling a process, comprising a control module and an output module, with the safety module comprising an energy source for providing a secure signal, the safety module comprising a means for comparing an actual status with a target status, and a shut-off means for transferring the process into a safe mode, the output means comprising an output for issuing the secure signal to control the process, and the output module comprising a means for detecting the actual status of the output.

According to the invention, in this way a control device is provided to control a process, particularly a safety-relevant process, which allows in a particularly simple and cost-effective manner by separating the components designed according to the above-mentioned safety standards, such as the safety module, and by standard components, such as the output module, a reliable detection of error functions or error statuses when issuing the secure signal, and in case of an error function or an error status transfers the process into a safe mode.

In a preferred manner the secure signal is embodied as a secure voltage according to the above-mentioned safety standards. Furthermore, it is preferred that the comparison means is embodied as a comparison means known from prior art to compare two conditions, such as to compare two voltages with each other, and the shut-off means is embodied as a shut-off means known from prior art, such as an electronic switch or a semiconductor switch. Additionally it is preferred that the outlet is embodied as an outlet known from prior art to emit a signal, such as a voltage, and the means for detecting the actual status is embodied as a means known from prior art to detect a status, such as, for example, an integrated voltage meter to detect said voltage.

According to another preferred embodiment of the invention it is provided that via the shut-off means the process can be transferred into the safe mode by shutting off the secure signal. Furthermore, it is preferred that a control and/or a secure control is provided to address the safety module and/or the output module and the target status can be predetermined by the control and/or the secure control. Furthermore, it is preferred that the detected actual status can be transmitted by the output module to the control and/or to the secure control and the actual status detected by the control and/or by the secure control can be transferred to the safety module. Furthermore, it is preferred that a field bus is provided for the communication between the safety module, the output module, and the control and/or the secure control.

Preferred further embodiments of the control device according to the invention are discernible from the analogy to the above-described control system.

The objective is attained according to the invention further by a method to control a process with a safety module and an output module, comprising the steps providing of a secure signal by the safety module, issuing of the secure signal to control the process by the output module, detection of the actual status of the secure signal issued by the output module, detection of a difference between the actual status and a target status for the process by the safety module, and transfer of the process into a safe mode when there is a difference.

According to the invention, in this way a method is provided to control a process, particularly a safety-relevant process, which in a cost-effective and simple manner allows a transfer of the process into a safe mode, particularly when there is a difference between the actual status of the secure signal issued and the target status. The method according to the invention allows an improved diagnostics of an error function with simultaneous cost savings when controlling a process, with a safety module designed according to the above-mentioned safety standards supplying a “standard” output module known from prior art to control a process with a secure signal such that in case of an error, thus when a difference is detected between the secure signal issued by the output module and detected and the target status, the process is transferred into the safe mode.

According to a preferred further development of the invention it is provided that the transfer of the process into the safe mode occurs by shutting off the secure signal. Furthermore, it is preferred that a control and/or a secure control for addressing the safety module and the output module is provided, with the method comprising the steps: predetermining of the actual status by the control, communicating of the actual status via the output module to the control and communicating of the actual status detected by the control to the safety module. In a preferred manner, the communication of the actual status occurs via a field bus protocol known from prior art and/or via a known field bus arrangement known from prior art.

Preferred further development of the method according to the invention is discernible analogous to the above-described control system and/or to the above-described control device.

### BRIEF DESCRIPTION

In the following, the invention is explained in greater detail with reference to the attached drawing based on a preferred embodiment.

It shows:

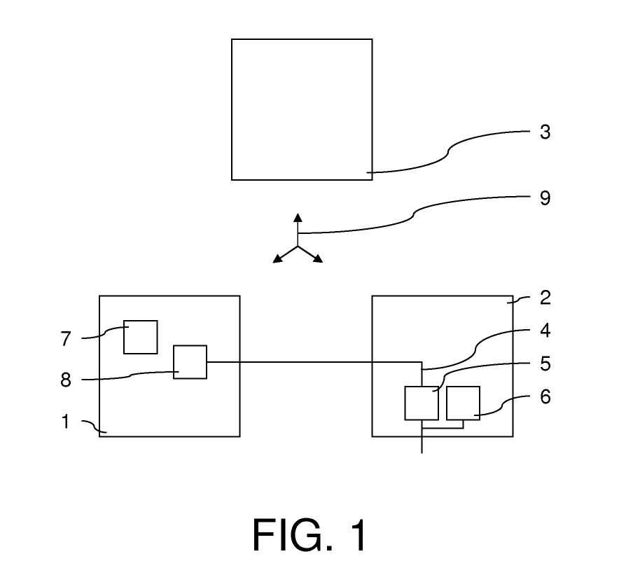

FIG. 1 a control system according to the invention to control a process according to a preferred exemplary embodiment of the invention in a schematic view.

FIG. 1 shows a control system to control a safety-relevant process of an arrangement with a safety module 1, an output module 2, and a control 3.

### DETAILED DESCRIPTION

The safety module 1, embodied according to the specifications of the safety standards, such as DIN EN 61508, DIN EN 62061, and/or DIN EN ISO 13849, provides a secure signal 4, which in the present case represents a voltage.

The output module 2, preferably designed similar to an output module for industrial control systems known from prior art, comprises an output 5 for issuing a secure signal 4 to control the process. Furthermore, the output module 2 comprises a means for the detection 6 of an actual status of the output 5. A diagnostic signal can be yielded from the means for detection 6, which reflects the actual status of the output 5.

The safety module 1 further comprises a comparison means 7 to compare the actual status with the target status as well as a shut-off means 8 for transferring the process into a safe mode. According to the preferred exemplary embodiment of the invention it is provided that the switching means 8 transfers the process into a safe mode by shutting off the secure signal 4. A safe mode here is considered such a status that prevents any potential endangerment of the facility and/or any operator and which must be assumed in case of an error. In the present case, the safe mode exists when the secure signal 4 is switched off via the shut-off means 8.

The output 5 is embodied as an output 5 known from prior art with a load being connected, such as an actuator, not shown here. In case of an embodiment of the secure signal 4 as a voltage the means for detecting 6 may be embodied as a device known from prior art for detecting a voltage. Additionally, the comparison means 7 and the shut-off means 8 may be embodied as a means known from prior art, for example, the shut-off means 8 embodied as an electronic power switch.

Due to the fact that the safety module 1 is embodied according to the specifications of the above-mentioned safety standards the safety module 1 detects the error statuses already described in the above-mentioned safety standards and the process can be transferred into a safe mode by shutting off the secure signal 4 via the shut-off means 8.

Such an embodiment known from prior art cannot detect, however, if there is a cross fault at the output 5. If there is a cross fault at the output 5, the comparison means 7 can detect, by a comparison of the actual status provided by the means for detection 6 with the target status, if there is a difference of the above-mentioned statuses. In such a case the shut-off means 8 shuts off the secure signal 4, so that the secure signal 4 is no longer applied to the output 5 and the process is transferred into a safe mode.

The control 3, which is embodied as a control for automation arrangements known from prior art communicates via a field bus 9 with the safety module 1 and the output module 2. The field bus 9 can be embodied as a field bus 9 known from prior art, such as interbus, profibus, or profinet. Additionally, the control 3 may be embodied as a bus master.

According to a preferred exemplary embodiment of the invention the control 3 generates the target status, based on which the safety module 1 generates the secure signal 4. The secure signal 4 is provided to the actuator via the output module 2 at the output 5. The means for detection 6 reads the secure signal 4 issued at the output 5 as the actual status and sends the actual status via the field bus 9 to the control 3. The control 3 sends the actual status detected via the field bus 9 to the security module 1. The comparison means 7 of the safety module 1 compares the detected actual status with the target status and, when the comparison means 7 detects a difference between the actual status and the target status, shuts off the secure signal 4.

As a result, a control system is provided, particularly for controlling a safety-relevant process, which can be used in a very cost-effective manner, particularly for safety-relevant applications.

### LIST OF REFERENCE CHARACTERS

Safety module 1
Output module 2
Control 3
Secure signal 4
Output 5
Means for detection 6
Comparison means 7
Shut-off means 8

1. A control system for controlling a process, the system comprising:
a safety module and an output module, with the safety module providing a secure signal, the output module comprising an output to issue the secure signal (4) for controlling the process, the output module comprising a means for the detection of an actual status of the output,
wherein the detected actual status is compared via the safety module with a target status, and in case of a difference between the actual status and the target status, the process is transferred into a safe mode.

2. A control system according to claim 1, wherein the process can be transferred into a safe mode by shutting off the secure signal.

3. A control system according to claim 1, wherein at least one of a control and a secure control is provided to address at least one of the safety module and the output module and the target status is can be predetermined by at least one of the control and by the secure control.

4. A control system according to claim 3, wherein the detected actual status is transmitted by the output module to at least one of the control and the secure control and the detected actual status transmitted by at least one of the control and the secure control to the safety module.

5. A control system according to claim 3, wherein a field bus is predetermined for the communication between the safety module, the output module, and at least one of the control and the secure control.

6. A control system according to claim 1, with the control system being embodied as a field bus arrangement.

7. The use of a control system according to claim 1 for the automation of an arrangement.

8. A control device for controlling a process, comprising:
a safety module and an output module, with the safety module comprising an energy source for providing a secure signal, the safety module comprising a comparison means for comparing an actual status with a target status and a shut-off means for transferring the process into a safe mode,
wherein the output module comprises an output for issuing the secure signal for controlling the process, and the output module comprising a means for the detection of the actual status of the output.

9. A control device according to claim 8, with the shut-off means being embodied such that the shut-off means transfers the process into a safe mode by shutting off the secure signal.

10. A control device according to claim 8, wherein at least one of a control and a secure control is provided to control at least one of the safety module and the output module and the target state is predetermined by at least one of the control and the secure control.

11. A control device according to claim 10, wherein the detected actual state is transmitted from the output module to at least one of the control and the secure control, and the detected actual status is transmitted from at least one of the control and the secure control to the safety module.

12. A control device according to claim 10, with a field bus being provided for the communication between the safety module, the output module, and at least one of the control and the secure control.

13. A method for controlling a process with a safety module and an output module, comprising the steps:
providing of a secure signal by the safety module;
issuing of the secure signal to control the process by the output module, wherein detection of the actual status of the issued secure signal is performed by the output module; and
determining a difference between the actual status and a target status for the process by the safety module, and transfer of the process into a safe mode when there is a difference.

14. A method according to claim 13, wherein the transfer of the process into the safe mode occurs by shutting off the secure signal.

15. A method according to claim 13, with at least one of a control and a secure control to control at least one of the safety module and the output module being provided, comprising the steps:
predetermining of the actual status by at least one of the control and the secure control;
communicating the actual status via the output module to at least one of the control and the secure control; and
communicating the detected actual status by at least one of the control and the secure control to the safety module.
